(19) United States
(12) Patent Application Publication
(10) Pub. No.: US 2023/0260185 A1
(43) Pub. Date: Aug. 17, 2023

(54) METHOD AND APPARATUS FOR CREATING DEEP LEARNING-BASED SYNTHETIC VIDEO CONTENT

(71) Applicant: SANGMYUNG UNIVERSITY INDUSTRY-ACADEMY COOPERATION FOUNDATION, Seoul (KR)

(72) Inventors: Dong Keun KIM, Seoul (KR); Hyun Jung KANG, Seoul (KR); Jeong Hwi LEE, Seoul (KR)

(73) Assignee: SANGMYUNG UNIVERSITY INDUSTRY-ACADEMY COOPERATION FOUNDATION, Seoul (KR)

(21) Appl. No.: 17/708,520

(22) Filed: Mar. 30, 2022

(30) Foreign Application Priority Data
Feb. 15, 2022 (KR) 10-2022-0019764

(51) Int. Cl. G06T 13/40; G06T 7/73; G06T 7/194; G06V 10/82

(52) U.S. Cl. CPC G06T 13/40; G06T 7/74; G06T 7/194; G06V 10/82; G06T 2207/30196

(57) ABSTRACT

The disclosed method may include: generating, by using an object generator, a first feature map object class having a multi-layer feature map downsampled from a frame image into different sizes by processing a video; obtaining an upsampled, multi-layer feature map by upsampling a multi-layer feature map of the first feature map object class, and obtaining a second feature map object class by performing a convolution operation on the up-sampled multi-layer feature map; detecting a human object corresponding to the one or more real humans from the second feature map, and separating the human objects; detecting, motions of key points of the human objects and converting motions of the real humans into data and generating motion information; creating synthetic video content by synthesizing the human objects into a background image; and displaying the synthetic video content on a display and selectively displaying the motion information.

### CROSS-REFERENCE TO RELATED APPLICATION

This application is based on and claims priority under 35 U.S.C. §119 to Korean Patent Application No. 10-2022-0019764, filed on Feb. 15, 2022, in the Korean Intellectual Property Office, the disclosure of which is incorporated by reference herein in its entirety.

### BACKGROUND

### 1. Field

One or more embodiments relate to a method and apparatus for creating deep-learning based synthetic video content, and more particularly, to a method of simultaneously extracting an image of a real person and pose information of the real person from a real-time video and synthesizing the extracted information with a separate image and displaying and using a synthetic image together with the pose information, and an apparatus for applying the method.

### 2. Description of the Related Art

Digital humans in a virtual space are artificially modeled image characters, which may imitate the outer appearance or posture of real people in a real space. The demand to express a real person through a digital human in a virtual space is increasing.

Digital humans may be applied to such fields as sports, online education, or animation.

External elements considered to express a real person as a digital human include realistic modeling of the digital human and imitated gestures, postures, and facial expressions. The gestures of a digital human are a very important communication element accompanying natural human expression. The purpose of digital humans is to verbally and non-verbally communicate with others.

Research into the diversification of an object of intention or information transfer by a character in a virtual space allows providing a higher image quality service.

### SUMMARY

One or more embodiments include a method and apparatus for extracting a character of a real person expressed in a virtual space in a raw state and detecting a pose or posture of the character and synthesizing the pose or posture with an additional image.

One or more embodiments include a method and apparatus for displaying a real person as a real image in a virtual space, detecting posture or gesture information of the real person, and converting movement of the real person into data and using the data.

Additional aspects will be set forth in part in the description which follows and, in part, will be apparent from the description, or may be learned by practice of the presented embodiments of the disclosure.

According to one or more embodiments, a deep learning-based synthetic video content creation method includes:
obtaining a video of one or more real humans by using a camera;
generating, by using an object generator, a first feature map object class having a multi-layer feature map downsampled from a frame image into different sizes by processing the video in units of frames;
obtaining an upsampled, multi-layer feature map by upsampling a multi-layer feature map of the first feature map object class, by using a feature map converter, and obtaining, by using the feature map converter, a second feature map object class by performing a convolution operation on the up-sampled multi-layer feature map by using the first feature map;
detecting, by using an object detector, a human object corresponding to the one or more real humans from the second feature map object class and separating the human objects;
by an image processor, detecting a motion of key points of the human objects, and converting motion of the real humans into data and generating motion information;
creating synthetic video content by synthesizing the human objects into a background image by using an image synthesizer; and
displaying the synthetic video content on a display and selectively displaying the motion information.

According to an embodiment of the present disclosure, the first feature map object class may have a size in which the multi-layer feature map is reduced in a pyramid shape.

According to another embodiment of the present disclosure, the first feature map object class may be generated by a convolutional neural network (CNN)-based model.

According to another embodiment of the present disclosure, the feature map converter may perform 1:1 transport convolution on the first feature map object class, in addition to upsampling.

According to another embodiment of the present disclosure, the object detector may generate a bounding box surrounding a human object, and a mask coefficient, from the second feature map object class, and detect human objects within the bounding box.

According to another embodiment of the present disclosure, the object detector may perform multiple feature extractions from the second feature map object and generate a mask of a certain size.

According to another embodiment of the present disclosure, a key point detector of the image processor performs key point detection on the human objects by using a machine-learning based model and extracts coordinates and motions of key points of the human objects and provides information about the coordinates and motions of the key points.

According to one or more embodiments, an apparatus for separating a human object from a video and estimating a posture of the human object includes:
a camera configured to obtain a video from one or more real humans;
an object generator configured to generate a first feature map object having a multi-layer feature map downsampled from a frame image into different sizes by processing the video in units of frames;
a feature map converter configured to obtain an upsampled, multi-layer feature map by upsampling a multi-layer feature map of the first feature map object class, and obtain a second feature map object class by performing a convolution operation on the up-sampled multi-layer feature map by using the first feature map;
an object detector configured to detect a human object corresponding to the one or more real humans from the second feature map object class and separate the human objects;
an image processor configured to detect motions of key points of the human objects and convert motions of the real humans into data;
an image synthesizer configured to synthesize the human objects into a separate background image; and
a display displaying an image obtained by the synthesizing.

According to an embodiment of the apparatus according to the present disclosure, the first feature map object class may have a size in which the multi-layer feature map is reduced in a pyramid shape.

According to another embodiment of the apparatus according to the present disclosure, the first feature map object class may be generated by using a convolutional neural network (CNN)-based model.

According to an embodiment of the apparatus according to the present disclosure, the feature map converter may perform 1:1 transport convolution on the first feature map object class, in addition to upsampling.

According to an embodiment of the apparatus according to the present disclosure, the object detector may generate a bounding box surrounding a human object, and a mask coefficient, from the second feature map object class, and detect human objects within the bounding box.

According to an embodiment of the apparatus according to the present disclosure, the object detector may perform multiple feature extractions from the second feature map object and generate a mask of a certain size.

According to an embodiment of the apparatus according to the present disclosure, the image processor may perform, by using a machine-learning based model, key point detection on the human objects separated in the above process and extract coordinates and motions of key points of the human objects and present information about the motions of the key points to the real humans.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a flowchart of a process of separating a human object from a video and estimating a pose of the human object and then creating real-virtual synthetic video content, according to an embodiment of the present disclosure;

FIG. 2 illustrates a resultant product of a human object extracted and separated from a raw image through a step-wise image processing process of a method according to an embodiment of the present disclosure;

FIG. 3 illustrates an image processing result of a process of separating a human object, according to an embodiment of the method according to the present disclosure;

FIG. 4 is a flowchart of a process of generating a feature map, according to an embodiment of the present disclosure;

FIG. 5 illustrates comparison between a raw image with a human object extracted from the raw image, according to an embodiment of the present disclosure;

FIG. 6 is a flowchart of a parallel processing process of extracting a human object from a raw image, according to an embodiment of the present disclosure;

FIG. 7 illustrates a prototype filter according to a prototype generation branch in parallel processing, according to an embodiment of the present disclosure;

FIG. 8 illustrates a resultant product obtained by linearly combining parallel processing results, according to an embodiment of the present disclosure;

FIG. 9 illustrates comparison between a raw image and an image obtained by separating a human object from the raw image by using a deep learning-based synthetic video content creation method according to an embodiment of the present disclosure;

FIG. 10 illustrates a key point inference result of a human object in a deep learning-based synthetic video content creation method according to an embodiment of the present disclosure; and

FIG. 11 is a flowchart of an image synthesis method according to the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The present disclosure will now be described more fully with reference to the accompanying drawings, in which exemplary embodiments of the present disclosure are shown. The present disclosure may, however, be embodied in many different forms, and should not be construed as being limited to the embodiments set forth herein; rather, these embodiments are provided so that this disclosure will be thorough and complete, and will fully convey the concept of the present disclosure to those skilled in the art. Throughout the specification, like reference numerals denote like elements. Further, in the drawings, various elements and regions are schematically illustrated. Thus, the present disclosure is not limited by relative sizes or intervals illustrated.

While such terms as “first,” “second,” etc., may be used to describe various components, such components must not be limited to the above terms. The above terms are used only to distinguish one component from another. For example, without departing the scope of rights of the present disclosure, a first element may be referred to as a second element, and similarly, the second element may be referred to as the first element.

The terms used in the present specification are merely used to describe particular embodiments, and are not intended to limit the present disclosure. An expression used in the singular form encompasses the expression in the plural form, unless it has a clearly different meaning in the context. In the present specification, it is to be understood that the terms such as “including” or “having”, etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may be added.

Unless defined differently, all terms used in the description, including technical and scientific terms, have the same meanings as generally understood by those skilled in the art. Terms commonly used and defined in dictionaries should be construed as having the same meanings as in the associated technical context of the present disclosure, and unless defined apparently in the description, these terms are not ideally or excessively construed as having formal meanings.

When an embodiment is implementable in another manner, a predetermined process order may be different from a described one. For example, two processes that are consecutively described may be substantially simultaneously performed or may be performed in an opposite order to the described order.

In addition, terms such as “..er (..or)”, “... unit”, “... module”, or the like refer to units that perform at least one function or operation, and the units may be implemented as computer-based hardware or software executed on a computer or as a combination of hardware and software.

The hardware is based on a general computer system including a main body, a keyboard, a monitor, and the like, and a video camera is included as an input device for image input.

Hereinafter, an embodiment of a method and apparatus for creating deep learning-based synthetic video content according to the present disclosure is described with reference to the accompanying drawings.

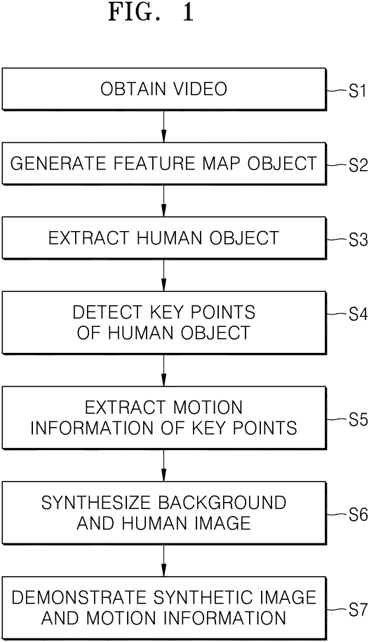

FIG. 1 illustrates an outline of a deep learning-based synthetic video content creation method as a basic image processing process of the method according to an embodiment the present disclosure.

Operation S1: A video of one or more real persons is obtained using a camera.

Operation S2: As a preprocessing procedure for image data, an object is formed by processing the video in units of frames. In the above operation, a first feature map object in an intermediate process having a multi-layer feature map is generated from an image of a frame unit (hereinafter, frame image), and a second feature map, which is a final feature map, is obtained through feature map transformation.

Operation S3: A human object corresponding to the one or more real persons in the frame image is detected through human object detection with respect to the second feature map, and the human object is separated from the frame image.

Operation S4: A key point of the human object is detected through a key point detection process with respect to the human object.

Operation S5: Information related to movement of the human object is extracted from motion of the key point of the human object, detected in the above operation.

Operation S6: Image content is created by synthesizing the human object extracted in the above operation, with a separately prepared background image or video into a single image.

Operation S7: The image content obtained by synthesizing a background is synthesized with the image of the real person, that is, the human object, is presented to the real person via a display, and at the same time, information related to motion of the human object is also selectively displayed.

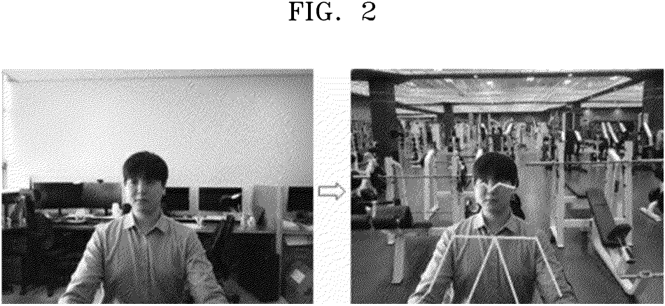

FIG. 2 shows a synthetic image in which a raw image and a human object extracted therefrom are synthesized, according to the present disclosure. FIG. 2 shows a view of a virtual fitness center, and as shown here, a human image from which the background is removed, that is, a human object, is synthesized into a separately prepared background image. As a background image that may be used here, still images or moving images of various environments may be used.

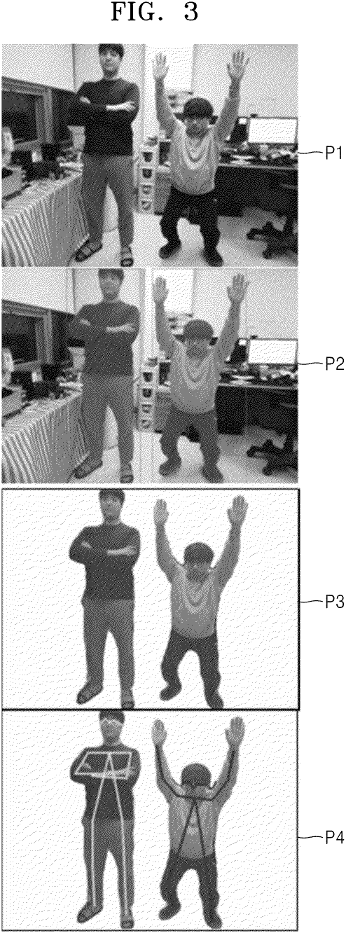

FIG. 3 shows an image processing result in a process of separating a human object.

P1 shows a raw image of a frame image separated from a video. P2 shows the human object separated from the raw image by using a feature map as described above. P3 shows a state in which the human object is separated from the raw image, that is, a state in which the background is removed. P4 shows a key point (solid line) detection result with respect to the human object.

The above process is characterized in that a key point is not detected directly from a raw image, but the key point is detected with respect to a human object detected and separated from the raw image.

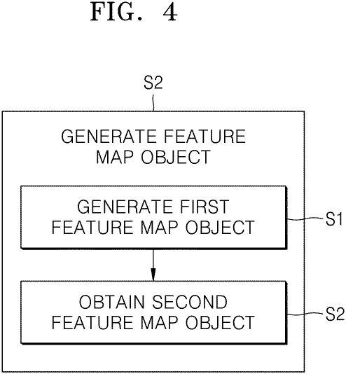

FIG. 4 illustrates an internal processing process of the operation of generating a feature map (S2) in the above process. According to the present disclosure, generation of a feature map is performed in two steps.

A first operation (S1) is an operation of generating a first feature map object having a multi-layer feature map, and then, in a second operation (S2), the first feature map is converted to form a second feature map. The above process is performed using a feature map generator, which is a software-type module for feature map generation performed on a computer.

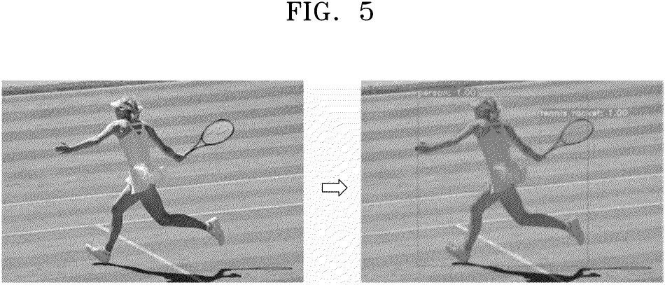

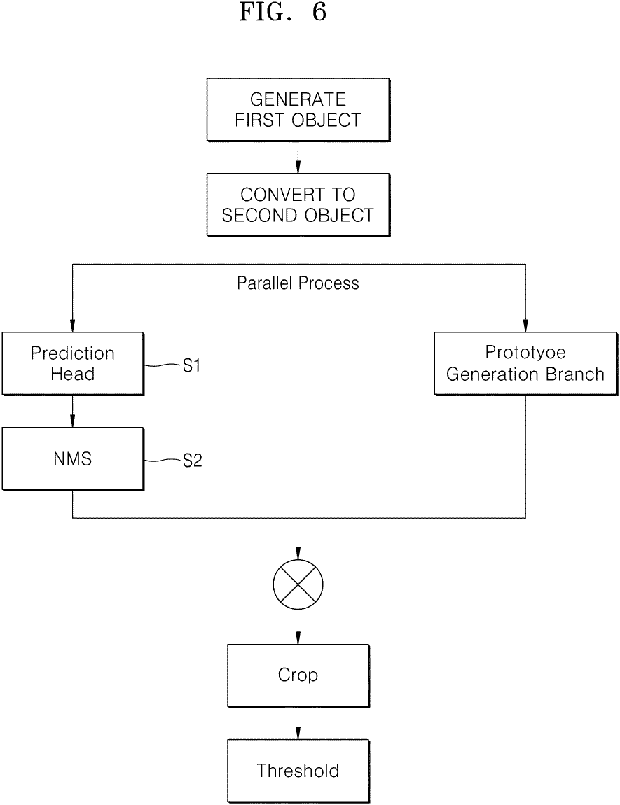

As shown in FIG. 5, the feature map generator detects a human object class called a person in a raw image (image frame) and performs instance segmentation to segment the human object. A representative example of the feature map generator is a One-Stage Instance Segmentation module (OSIS), which simultaneously performs object detection and instance segmentation and thus has a very high processing speed, and has a processing process as illustrated in FIG. 6.

The first feature map object class may have a size in which the multi-layer feature map is reduced in a pyramid shape, and may be generated by a convolutional neural network (CNN)-based model.

The first feature map may be implemented as a backbone network, for example, a Resnt50 model may be applied. The backbone network may have a number of downsampled, for example, five feature maps of different sizes, by a convolution operation.

The second feature map may have, for example, a Feature Pyramid Network (FPN) structure. The feature map converter may perform 1:1 transport convolution on the first feature map object class, in addition to upsampling. In detail, the second feature map may have a structure in which a feature map having a size proportional to each layer is generated by using a feature map of each layer of backbone networks, and the feature maps are added to each other, starting from an uppermost layer. The second feature map is robust against changes in scale because both object information predicted in an upper layer and small object information in a lower layer may be used.

Processing of the second feature map is performed through a subsequent parallel processing process.

In a first parallel processing process, a process of a prediction head and non-maximum suppression (NMS) is performed, and a second parallel processing process is a prototype generation branch process.

A prediction head is divided into three branches, that is, Box branch, Class branch, and Coefficient branch.

Class branch: Three anchor boxes for each pixel of a feature map are created, and confidence with respect to object class is calculated for each anchor box.

Box branch: Coordinates (x, y, w, h) of the three anchor boxes are predicted.

Coefficient branch: Mask coefficients for k feature maps are predicted by adjusting each anchor box to localize only one instance.

According to NMS, the other bounding boxes except for a most accurate prediction box among predicted bounding boxes is removed. Here, an intersection area between bounding boxes is selected in the entire bounding box area occupied by several bounding boxes, determining one accurate bounding box.

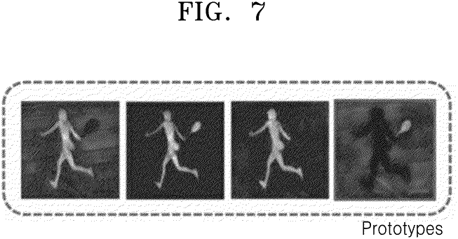

In prototype generation, which is a second parallel processing process, a certain number, for example, k masks, are generated by extracting features from a lowermost layer P3 of a FPN in several steps. FIG. 7 shows four types of prototype masks.

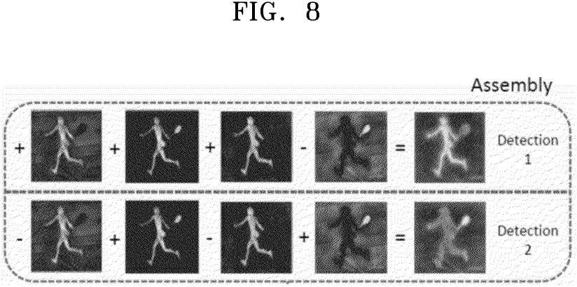

After the two parallel processing processes are performed as above, in an assembly ⊕, mask coefficients of the prediction head are linearly combined with the prototype masks to extract segments for each instance. FIG. 8 shows a detection result of a mask for each instance, obtained by combining mask coefficients with a prototype mask.

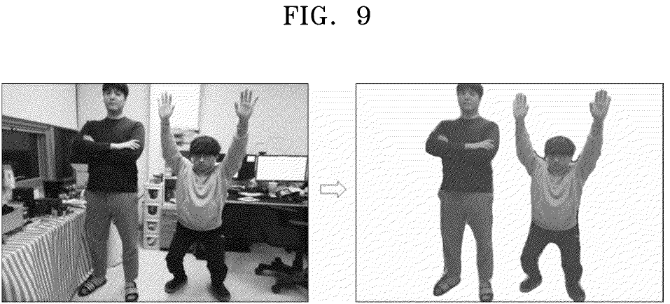

As above, after detecting the mask for each instance, an image is cut through cropping, and a threshold is applied thereto to determine a final mask. In applying the threshold, a final mask is determined based on the threshold value by checking a reliability value of each instance, and by using the final mask, a human object is extracted from an image by using the final mask, as shown in FIG. 9.

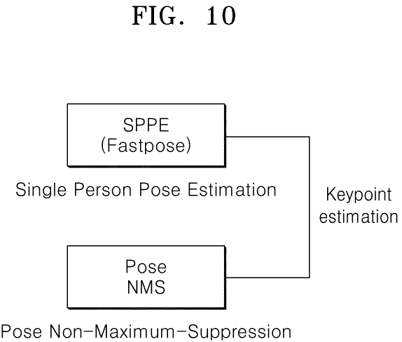

FIG. 10 illustrates a method of extracting body key points from the human object.

Key points of a human object are individually extracted for all individuals in an image. A key point is two-dimensional coordinates in an image, and to track the key point, a pre-trained deep learning model may be used. cmu, mobilenet_thin, mobilenet_v2_large, mobilenet_v2_small, tf-pose-estimation, and openpose or the like may be applied as a pre-trained deep learning model.

In the present embodiment, Single Person Pose Estimation (SPPE) is performed on found human objects, and in particular, key point estimation or posture estimation for all human objects is performed by a top-down method, and a result thereof is as shown in FIG. 2.

The top-down method is a two-step key point extraction method of performing pose estimation based on bounding box coordinates of each human object. A bottom-up method is faster than the top-down method because positions of human objects and positions of key points are simultaneously estimated, but is disadvantageous in terms of accuracy, and the performance thereof depends on the accuracy of a bounding box. In the pose detection as above, Regional Multi-person Pose Estimation (RMPE) suggested by Fang et al. may be applied.

A joint point prediction model according to the related art obtains a joint point after detecting an object. However, according to the method of the present disclosure, by processing instance segmentation in parallel in a human object detection operation, all of human object detection and segmentation and even prediction of joint points may all be performed at once.

According to the present disclosure, processing may be performed at a high speed by using a process-based multi-thread method, and the processing may be performed in the order of data pre-processing -> object detection and segmentation -> joint point prediction -> image output. In an image output operation, apply_async, which is a synchronization method call function that is frequently used in multi-processors, may be applied so that processes may be performed sequentially, and when processes are processed in parallel, they may be executed sequentially.

In the present disclosure, by adding instance segmentation to the existing joint point prediction model, segmentation of backgrounds and instances may be possible in applicable fields. Accordingly, at the same time when instances and a background are segmented, the background may be changed to another image, and thus, a virtual background may be applied in various application fields.

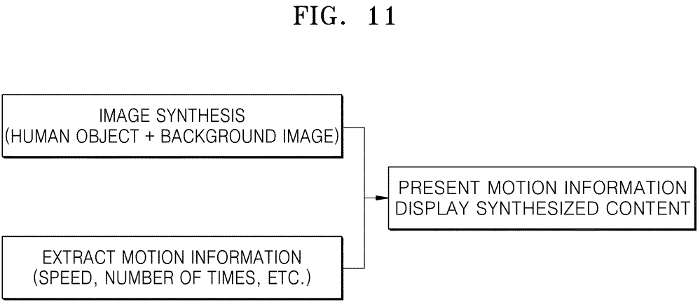

FIG. 11 illustrates a process of synthesizing a human object extracted through the above process and motion information of the human object into a virtual screen, and FIG. 2 shows the result of synthesizing the human object into the virtual screen.

According to the present disclosure, for example, a workout image in a real space is synthesized into a virtual space, and the synthetic image is displayed on a display, and a workout state proceeding in the real space on the display may be detected from motion of key points, and displayed on the display. Information that may be obtained through the detection of key points may include counts of speed and number of times of all exercise that requires motion of human joints, for example, push-ups, pull-ups, walking or running gait. The present disclosure may be applied to various fields by displaying a motion image of a real user in a virtual space together with motion information. When applied to a video workout system, the effect of workout may be enhanced by making the real user’s workout more interesting.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A deep learning-based synthetic video content creation method comprising:
obtaining a video of one or more real humans by using a camera;
generating, by using an object generator, a first feature map object class having a multi-layer feature map downsampled from a frame image into different sizes by processing the video in units of frames;
obtaining an upsampled, multi-layer feature map by upsampling a multi-layer feature map of the first feature map object class by using a feature map converter, and obtaining, by using the feature map converter, a second feature map object class by performing a convolution operation on the up-sampled multi-layer feature map by using the first feature map;
detecting, by using an object detector, a human object corresponding to the one or more real humans from the second feature map object class and separating the human objects;
by an image processor, detecting, motions of key points of the human objects, and converting motions of the real humans into data and generating motion information;
creating synthetic video content by synthesizing the human objects into a background image by using an image synthesizer; and
displaying the synthetic video content on a display and selectively displaying the motion information.

2. The deep learning-based synthetic video content creation method of claim 1, wherein the first feature map object class has a size in which the multi-layer feature map is reduced in a pyramid shape.

3. The deep learning-based synthetic video content creation method of claim 1, wherein the first feature map object class is generated by a convolutional neural network (CNN)-based model.

4. The deep learning-based synthetic video content creation method of claim 3, wherein the object detector generates a bounding box surrounding a human object, and a mask coefficient, from the second feature map object class, and detects human objects within the bounding box.

5. The deep learning-based synthetic video content creation method of claim 1, wherein the object detector generates a bounding box surrounding a human object, and a mask coefficient, from the second feature map object class, and detects human objects within the bounding box.

6. The deep learning-based synthetic video content creation method of claim 1, wherein the object detector performs multiple feature extractions from the second feature map object and generates a mask of a certain size.

7. The deep learning-based synthetic video content creation method of claim 3, wherein the object detector performs multiple feature extractions from the second feature map object and generates a mask of a certain size.

8. The deep learning-based synthetic video content creation method of claim 4, wherein the object detector performs multiple feature extractions from the second feature map object and generates a mask of a certain size.

9. The deep learning-based synthetic video content creation method of claim 1, wherein the image processor performs key point detection on the human objects by using a machine-learning based model and extracts coordinates and motions of key points of the human objects and provides information about the coordinates and motions of the key points.

10. The deep learning-based synthetic video content creation method of claim 3, wherein the key point detection performs key point detection on the human objects by using a machine-learning based model and extracts coordinates and motions of key points of the human objects and provides information about the coordinates and motions of the key points.

11. A deep learning-based synthetic video content creating apparatus comprising:
a camera configured to obtain a video from one or more real humans;
an object generator configured to generate a first feature map object having a multi-layer feature map downsampled from a frame image into different sizes by processing the video in units of frames;
a feature map converter configured to obtain an upsampled, multi-layer feature map by upsampling a multi-layer feature map of the first feature map object class, and obtain a second feature map object class by performing a convolution operation on the up-sampled multi-layer feature map by using the first feature map;
an object detector configured to detect a human object corresponding to the one or more real humans from the second feature map object class and separate the human objects;
an image processor configured to detect motions of key points of the human objects and convert motions of the real humans into data;
an image synthesizer configured to synthesize the human objects into a separate background image; and
a display displaying an image obtained by the synthesizing.

12. The deep learning-based synthetic video content creating apparatus of claim 11, wherein the object generator generates the first feature map object class having a size in which the multi-layer feature map is reduced in a pyramid shape.

13. The deep learning-based synthetic video content creating apparatus of claim 12, wherein the object generator generates the first feature map object class by using a convolutional neural network (CNN)-based model.

14. The deep learning-based synthetic video content creating apparatus of claim 11, wherein the object generator generates the first feature map object class by using a convolutional neural network (CNN)-based model.

15. The deep learning-based synthetic video content creating apparatus of claim 11, wherein the object detector generates a bounding box surrounding a human object, and a mask coefficient, from the second feature map object class, and detects human objects within the bounding box.

16. The deep learning-based synthetic video content creating apparatus of claim 11, wherein the object detector performs multiple feature extractions from the second feature map object and generates a mask of a certain size.

17. The deep learning-based synthetic video content creating apparatus of claim 11, wherein the image processor performs key point detection on the human objects by using a machine-learning based model and extracts coordinates and motions of key points of the human objects and provides information about the coordinates and motions of the key points.

18. The deep learning-based synthetic video content creating apparatus of claim 12, wherein the key point detection performs key point detection on the human objects by using a machine-learning based model and extracts coordinates and motions of key points of the human objects and provides information about the coordinates and motions of the key points.

19. The deep learning-based synthetic video content creating apparatus of claim 13, wherein the key point detection performs key point detection on the human objects by using a machine-learning based model and extracts coordinates and motions of key points of the human objects and provides information about the coordinates and motions of the key points.
